(19) United States
(12) Patent Application Publication
(10) Pub. No.: US 2026/0273974 A1
(43) Pub. Date: Sep. 17, 2026

(54) CONVEYANCE DEVICE AND RECORDING DEVICE

(71) Applicant: SEIKO EPSON CORPORATION, Tokyo (JP)

(72) Inventors: Jun YAMADA, MATSUMOTO-SHI (JP); Masaki KOBAYASHI, MATSUMOTO-SHI (JP)

(21) Appl. No.: 19/563,287

(22) Filed: Mar. 11, 2026

(30) Foreign Application Priority Data
Mar. 11, 2025 (JP) 2025-038090

(51) Int. Cl. B41J 15/16; B41J 15/04

(52) U.S. Cl. CPC B41J 15/165; B41J 15/04

(57) ABSTRACT

A conveyance device 52 according to the present disclosure includes: a feeding unit 2 configured to feed a medium 7 from a roll body R1; a conveying unit 3 configured to intermittently convey the medium fed from the roll body in a conveying direction; a tension bar 20 configured to press the medium to apply a tension T1, the tension bar being movably disposed between the feeding unit 2 and the conveying unit 3 in a conveying path 18; a tension bar moving unit 21 configured to move the tension bar 20; and a control unit 15 configured to control each of operations performed by the feeding unit 2, the conveying unit 3, and the tension bar moving unit 21, in which the control unit 15 changes a magnitude of the tension T1 based on timing information 54 designating a timing at which a magnitude of the tension T1 is changed.

The present application is based on, and claims priority from JP Application Serial Number 2025-038090, filed Mar. 11, 2025, the disclosure of which is hereby incorporated by reference herein in its entirety.

### BACKGROUND

### 1. Technical Field

The present disclosure relates to a conveyance device and a recording device.

### 2. Related Art

Examples of the related art of a device of such a type include a device disclosed in JP-A-2023-022374. JP-A-2023-022374 discloses the following.

A supply bar driving mechanism adjusts a driving force applied to a supply bar support member and thus adjusts a tension applied to a medium as a supply bar member swings.

JP-A-2023-022374 is an example of the related art.

In JP-A-2023-022374, when the supply bar member swings, an abnormal noise may be generated due to friction with the medium, and therefore there is room for improvement in this respect.

### SUMMARY

According to an aspect of the present disclosure, there is provided a conveyance device including: a feeding unit configured to rotatably hold a roll body around which a medium is wound and to feed the medium from the roll body; a conveying unit configured to intermittently convey the medium fed from the roll body in a conveying direction; a tension bar configured to press the medium to apply a tension, the tension bar being movably disposed between the feeding unit and the conveying unit in a conveying path along which the medium is conveyed; a tension bar moving unit configured to move the tension bar; and a control unit configured to control each of operations performed by the feeding unit, the conveying unit, and the tension bar moving unit, in which the control unit changes a magnitude of the tension based on timing information designating a timing at which a magnitude of the tension is changed.

According to another aspect of the present disclosure, a recording device includes: a recording unit configured to perform recording on a conveyed medium; and a conveyance device that is located upstream of the recording unit in the conveying direction and conveys the medium toward the recording unit, and the conveyance device is the conveyance device according to any one of first to sixth aspects to be described later.

### BRIEF DESCRIPTION OF THE DRAWINGS

FIG. 1 is a schematic side view of a schematic configuration of a recording device including a conveyance device according to Embodiment 1.

FIG. 2 is a plan view of a tension applying unit according to Embodiment 1.

FIG. 3 is an enlarged schematic side view of a conveyance device according to Embodiments 1, 2, and 3.

FIG. 4 is a block configuration diagram of a control unit according to Embodiments 1, 2, and 3.

FIG. 5 is a time chart of an operation performed by the control unit according to Embodiments 1, 2, and 3.

FIG. 6 is a time chart of an operation performed by the control unit according to Embodiments 1, 2, and 3.

FIG. 7 is a part of a time chart of the operation performed by the control unit according to Embodiments 1, 2, and 3.

### DESCRIPTION OF EMBODIMENTS

First, an overview of the present disclosure will be described.

In order to solve the above problem, a conveyance device according to a first aspect of the present disclosure includes: a feeding unit configured to rotatably hold a roll body around which a medium is wound and to feed the medium from the roll body; a conveying unit configured to intermittently convey the medium fed from the roll body in a conveying direction; a tension bar configured to press the medium to apply a tension, the tension bar being movably disposed between the feeding unit and the conveying unit in a conveying path along which the medium is conveyed; a tension bar moving unit configured to move the tension bar; and a control unit configured to control each of operations performed by the feeding unit, the conveying unit, and the tension bar moving unit. The control unit changes a magnitude of the tension based on timing information designating a timing at which a magnitude of the tension is changed.

When the medium is conveyed in a state in which the tension bar is in contact with the conveyed medium to apply a tension thereto, an abnormal noise may be generated from a part where the tension bar and the medium slide against each other.

According to the aspect, the conveyance device includes the tension bar that is disposed to be movable between the feeding unit and the conveying unit in the conveying path along which the medium is conveyed, and presses the medium to apply a tension thereto, and the tension bar moving unit that moves the tension bar. Further, the conveyance device includes the control unit that controls each of operations performed by the feeding unit, the conveying unit, and the tension bar moving unit. The control unit is configured to change a magnitude of the tension based on timing information designating a timing at which a magnitude of the tension is changed.

Accordingly, since the magnitude of the tension applied to the medium of the tension bar that slides on the medium changes, it is possible to deviate from a sliding state in which an abnormal noise is generated, and thus it is possible to prevent the generation of the abnormal noise.

Since the magnitude of the tension is changed based on the timing information, the magnitude of the tension can be changed at a timing of a state in which the abnormal noise is generated, that is, at an appropriate timing, and the generation of the abnormal noise can be prevented.

A conveyance device according to a second aspect of the present disclosure is an aspect dependent on the first aspect in which the timing information is the position information in the movement direction of the moving tension bar.

According to the aspect, the timing information is the position information in the movement direction of the moving tension bar. Accordingly, it is possible to change the magnitude of the tension at an appropriate timing based on the position information of the tension bar, thereby preventing the generation of the abnormal noise.

A conveyance device according to a third aspect of the present disclosure is an aspect dependent on the second aspect in which the tension bar moving unit includes a rotary unit and a rotary encoder, and the position information is acquired via the rotary encoder.

According to the aspect, since the position information is acquired via the rotary encoder, the position information can be acquired with a simple structure.

A conveyance device according to a fourth aspect of the present disclosure is an aspect dependent on the first aspect in which the timing information is speed information of the moving tension bar.

According to the aspect, the timing information is the speed information of the moving tension bar. Accordingly, it is possible to change the magnitude of the tension at an appropriate timing based on the speed information of the tension bar, thereby preventing the generation of the abnormal noise.

A conveyance device according to a fifth aspect of the present disclosure is an aspect dependent on the fourth aspect in which the tension bar moving unit includes a rotary unit and a rotary encoder, and the speed information is acquired via the rotary encoder.

According to the aspect, since the speed information is acquired via the rotary encoder, the speed information can be acquired with a simple structure.

A conveyance device according to a sixth aspect of the present disclosure is an aspect dependent on the first aspect, and is configured such that the control unit is configured to execute an operation of starting a downward movement of the tension bar located at an upper position by the tension bar moving unit after the conveying unit stops, and moving the tension bar located at a lower position upward by the tension bar moving unit after the conveying unit resumes the conveyance of the medium, and the timing information is (1) a first predetermined time after the conveying unit stops and immediately before the tension bar reaches the lower position, and (2) a second predetermined time after the conveying unit resumes the conveyance of the medium and immediately after the tension bar starts to move upward from the lower position.

According to the aspect, the timing information is (1) the first predetermined time after the conveying unit stops and immediately before the tension bar reaches the lower position, and (2) the second predetermined time after the conveying unit resumes the conveyance of the medium and immediately after the tension bar starts to move upward from the lower position. Accordingly, it is possible to change the magnitude of the tension at an appropriate timing without using the rotary encoder, thereby preventing the generation of the abnormal noise.

According to a seventh aspect of the present disclosure, a recording device includes: a recording unit configured to perform recording on a conveyed medium; and a conveyance device that is located upstream of the recording unit in a conveying direction and conveys the medium toward the recording unit, and the conveyance device is the conveyance device according to any one of first to sixth aspects.

According to the aspect, the recording device can achieve effects similar to the effects described in any one of the first to sixth aspects.

### EMBODIMENTS

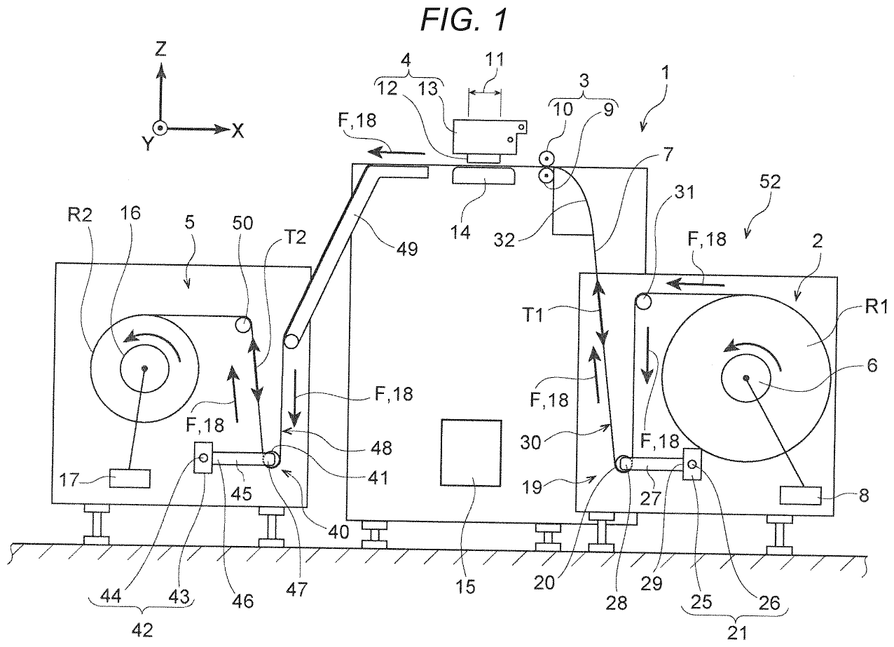

Hereinafter, a conveyance device according to embodiments of the present disclosure and a recording device including the conveyance device will be specifically described with reference to FIGS. 1 to 7. Here, a case in which the recording device is an inkjet printer will be described.

In the description below, three axes orthogonal to one another are respectively defined as an X axis, a Y axis, and a Z axis as illustrated in the drawings. Directions indicated by arrows of the three axes (X, Y, and Z) are positive (+) directions of the respective directions, and opposite directions thereof are negative (−) directions. A Z-axis direction corresponds to a vertical direction, that is, a direction in which the gravity acts, a +Z direction represents a vertically upward direction and a −Z direction represents a vertically downward direction. An X-axis direction and a Y-axis direction are equivalent to a horizontal direction. The +X direction indicates a right direction of the recording device, and the −X direction indicates a left direction of the recording device. A +Y direction indicates a front direction of the recording device and a −Y direction indicates a rear direction of the recording device.

### Description of Overview of Recording Device

As illustrated in FIG. 1, a recording device 1 according to the present embodiment includes a feeding unit 2, a conveying unit 3, a recording unit 4, a take-up unit 5, and a control unit 15.

The feeding unit 2 has a support shaft 6, and a long medium 7 is set on the support shaft 6 in a state of a roll body R1. The feeding unit 2 feeds the medium 7 in a conveying direction F by rotating the roll body R1 by rotating the support shaft 6. The support shaft 6 rotates as a rotational force is applied thereto by a rotation mechanism 8.

The rotation mechanism 8 is driven by power transmitted from a motor, which is not illustrated, according to a control signal of the control unit 15.

The conveying unit 3 intermittently conveys the medium 7 in the conveying direction F. Here, the conveying unit 3 nips the medium 7 between a pair of a drive roller 9 and a driven roller 10 and thus conveys the medium 7. A dimension L of the medium 7 by which the conveying unit 3 feeds the medium 7 per feed in the intermittent conveyance is a dimension by which the recording unit 4 can perform recording per reciprocation, which will be described later.

The drive roller 9 is driven as power is transmitted thereto from a motor, which is not illustrated, according to a control signal of the control unit 15. That is, the conveying unit 3 intermittently conveys the medium 7.

The recording unit 4 ejects an ink from a recording head 12 to the fed medium 7 in a recording execution area 11 and thus performs recording. The recording head 12 is mounted on a carriage 13. The carriage 13 reciprocates in a width direction (Y-axis direction) of the medium 7 intersecting the conveying direction F. When the conveying unit 3 is stopped and the medium 7 is also stopped, the recording unit 4 performs recording by ejecting the ink while reciprocating.

The recording unit 4 executes a recording operation by the reciprocation and the ink ejection according to a control signal from the control unit 15. In the recording execution area 11, the medium 7 is supported by a platen 14.

The take-up unit 5 includes a support shaft 16. The long medium 7 is set in a state in which a distal end part thereof is fixed to the support shaft 16. The take-up unit 5 rotates the support shaft 16 and thus winds up the medium 7 to form a roll body R2. The support shaft 16 rotates as a rotational force is applied thereto by a rotation mechanism 17.

The rotation mechanism 17 is driven by power transmitted from a motor, which is not illustrated, according to a control signal of the control unit 15.

### Tension Applying Unit on Feeding Unit Side

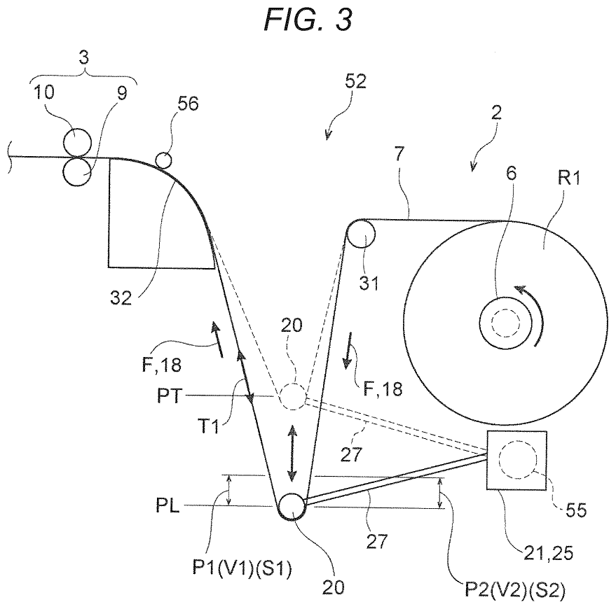

Further, a tension applying unit 19 is provided in a conveying path 18 between the feeding unit 2 and the conveying unit 3. The tension applying unit 19 includes a tension bar 20 that is in contact with and presses the medium 7 and thus applies a tension T1 thereto (FIGS. 1 and 3), and a tension bar moving unit 21 that moves the tension bar 20.

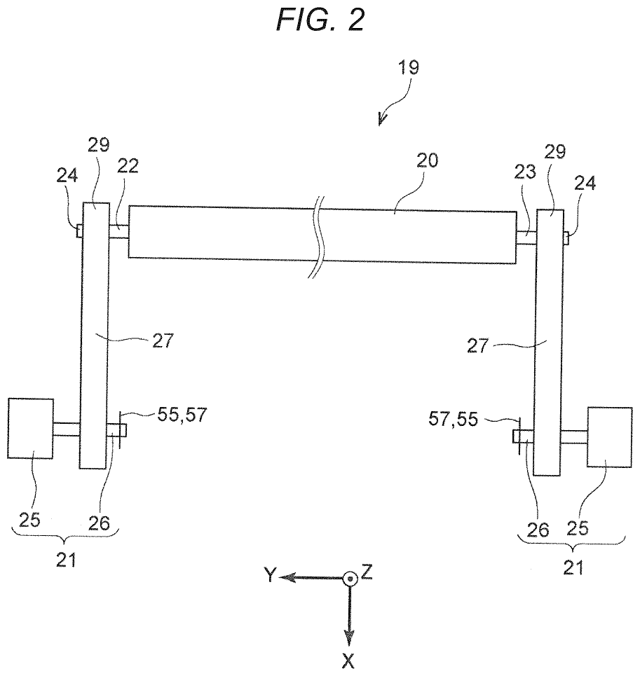

As illustrated in FIG. 2, the tension applying unit 19 is disposed at two end parts 22 and 23 in the longitudinal direction of the tension bar 20. The tension bar 20 is fixed to a bar support shaft 24.

The tension bar moving unit 21 includes a rotary unit 25 and a rotary shaft 26 that rotates integrally with the rotary unit 25. One end part 28 of an arm part 27 is fixed to the rotary shaft 26. A distal end part 29 of the arm part 27 is a free end and is fixed to the two end parts 22 and 23 of the tension bar 20. That is, when the rotary unit 25 rotates, the distal end part 29 of the arm part 27 swings with the one end part 28 side serving as a swing fulcrum, and the tension bar 20 is moved by this swing.

The tension bar moving unit 21 is driven by power transmitted from a motor, which is not illustrated, according to a control signal of the control unit 15.

The medium 7 fed from the feeding unit 2 is conveyed in the conveying direction F in a state in which an extra length part 30 is formed between the roll body R1 and the conveying unit 3. The tension bar 20 is in contact with the medium 7 at the extra length part 30 to apply the tension T1 thereto, and brings the medium 7 at the extra length part 30 into a stretched state. Specifically, the medium 7 between a guide roller 31 and a guide surface 32 located immediately before the conveying unit 3, the guide roller 31 and the guide surface 32 forming the conveying path 18, is in a substantially U-shaped posture via the tension bar 20.

As illustrated in FIG. 3, when the conveying unit 3 intermittently conveys the medium 7, the tension bar 20 reciprocates up and down between a lower position PL and an upper position PT in the state in which the tension T1 is applied to the medium 7 fed from the feeding unit 2.

When recording is being performed by the recording unit 4 in a state in which the conveying unit 3 is stopped, the tension bar 20 moves downward to increase the length of the medium 7 located at the extra length part 30. When recording by the recording unit 4 is completed, the tension bar 20 is located at the lower position PL. At this time, the extra length part 30 has the longest length.

When the recording by the recording unit 4 is completed and the conveyance of the medium 7 by the conveying unit 3 is resumed, the tension bar 20 starts to move upward. The conveying unit 3 stops when the medium 7 is fed by the feeding dimension L per feed. When the conveying unit 3 stops, the tension bar 20 is located at the upper position PT. At this time, the extra length part 30 has the shortest length. Subsequently, the tension bar 20 starts to move toward the lower position PL and then reaches the lower position PL. After that, the tension bar 20 reciprocates between the lower position PL and the upper position PT in the state in which the tension T1 is applied to the medium 7, in synchronization with the intermittent conveyance of the conveying unit 3.

The operation in which the tension bar 20 reciprocates between the lower position PL and the upper position PT in the state in which the tension T1 is applied to the medium 7, in synchronization with the intermittent conveyance of the conveying unit 3, is executed under the control of the control unit 15.

### Tension Applying Unit on Take-Up Unit Side

A tension applying unit 40 is also provided in the conveying path 18 between the conveying unit 3 and the take-up unit 5. The tension applying unit 40 includes a tension bar 41 that is in contact with and presses the medium 7 and thus applies a tension T2 thereto (FIG. 1), and a tension bar moving unit 42 that moves the tension bar 41.

Similarly to the tension applying unit 19, the tension applying unit 40 is disposed at two end parts in the longitudinal direction of the tension bar 41, and the tension bar 41 is fixed to a bar support shaft, which is not illustrated.

As in the tension applying unit 19, the tension bar moving unit 42 includes a rotary unit 43 and a rotary shaft 44 that rotates integrally with the rotary unit 43. One end part 46 of an arm part 45 is fixed to the rotary shaft 44. A distal end part 47 of the arm part 45 is a free end and is fixed to the two end parts of the tension bar 41. That is, when the rotary unit 43 rotates, the distal end part 47 of the arm part 45 swings with the one end part 46 side serving as a swing fulcrum, and the tension bar 41 is moved up and down by this swing.

The tension bar moving unit 42 is driven by power transmitted from a motor, which is not illustrated, according to a control signal of the control unit 15.

As in the tension applying unit 19, the medium 7 on which recording is executed by the recording unit 4 is conveyed in the conveying direction F in a state in which an extra length part 48 is formed between the roll body R2 and the conveying unit 3. The tension bar 41 is in contact with the medium 7 at the extra length part 48 to apply the tension T2 thereto, and brings the medium 7 at the extra length part 48 into a stretched state. Specifically, the medium 7 between a guide frame 49 and a guide roller 50 located immediately before the take-up unit 5, the guide frame 49 and the guide roller 50 forming the conveying path 18, is in a substantially U-shaped posture via the tension bar 41.

When the conveying unit 3 intermittently conveys the medium 7, the tension bar 41 reciprocates up and down between a lower position and an upper position, which is not illustrated, in the state in which the tension T2 is applied to the medium 7 conveyed from the conveying unit 3.

When recording is being performed by the recording unit 4 in a state in which the conveying unit 3 is stopped, the tension bar 41 moves upward to reduce the length of the medium 7 located at the extra length part 48. When recording by the recording unit 4 is completed, the tension bar 41 is located at the upper position PT. At this time, the extra length part 48 has the shortest length.

When the recording by the recording unit 4 is completed and the conveyance of the medium 7 by the conveying unit 3 is resumed, the tension bar 41 starts to move downward. The conveying unit 3 stops when the medium 7 is fed by the feeding dimension L per feed. When the conveying unit 3 stops, the tension bar 41 is located at the lower position. At this time, the extra length part 48 has the longest length. Subsequently, the tension bar 41 starts to move toward the upper position and reaches the upper position. Thereafter, the tension bar 41 reciprocates between the lower position and the upper position in the state in which the tension T2 is applied to the medium 7, in synchronization with the intermittent conveyance of the conveying unit 3.

The operation in which the tension bar 41 reciprocates between the lower position and the upper position in the state in which the tension T2 is applied to the medium 7, in synchronization with the intermittent conveyance of the conveying unit 3, is executed under the control of the control unit 15.

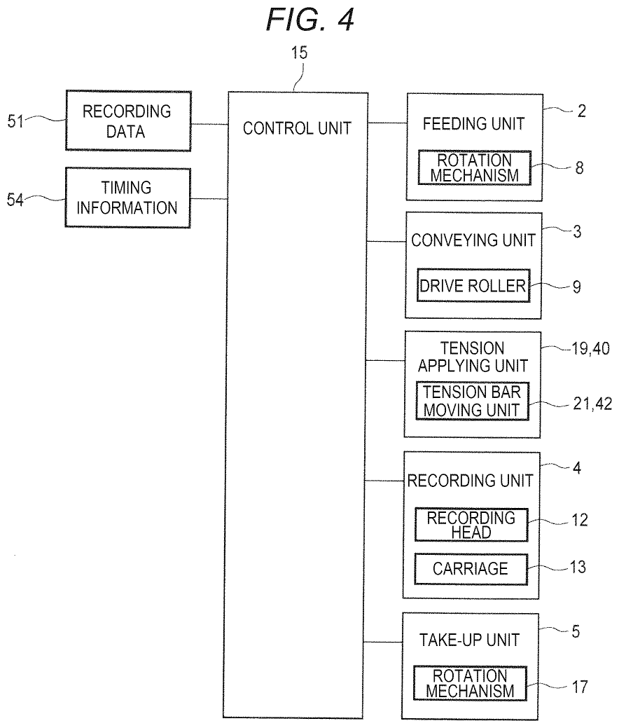

The control unit 15 is implemented as illustrated in the block diagram of FIG. 4. That is, the control unit 15 controls each of operations of the feeding unit 2, the conveying unit 3, the recording unit 4, the take-up unit 5, and the tension bar moving units 21 and 42.

Specifically, upon receiving recording data 51 (FIG. 4), the control unit 15 causes the recording unit 4 to execute the above-described recording operation. Simultaneously with the recording operation, the control unit 15 causes the feeding unit 2 to execute the above-described feeding operation of the medium 7, causes the conveying unit 3 to execute the above-described conveyance operation of the medium 7, causes the take-up unit 5 to execute the above-described winding-up operation, and causes the tension bar moving units 21 and 42 to execute the tension applying operation on the medium 7.

### Embodiment 1

Next, Embodiment 1 of a conveyance device 52 according to the present disclosure will be described with reference to FIGS. 3 to 5. The conveyance device 52 according to the present embodiment is an element of the recording device 1.

The conveyance device 52 according to the present embodiment includes the feeding unit 2 that rotatably holds the roll body R1 formed of the wound medium 7 and can feed the medium 7 from the roll body R1, and the conveying unit 3 that intermittently conveys the medium 7 fed from the roll body R1 in the conveying direction F. Further, the conveyance device 52 includes the tension bar 20 that is movably disposed between the feeding unit 2 and the conveying unit 3 in the conveying path 18 on which the medium 7 is conveyed, the tension bar moving unit 21 that moves the tension bar 20, and the control unit 15.

Since the structures of the feeding unit 2, the conveying unit 3, the tension bar 20, and the tension bar moving unit 21 are already described in the description of the recording device 1, the description thereof will be omitted.

As described above, the control unit 15 controls the operations of the feeding unit 2, the conveying unit 3, and the tension bar moving unit 21.

In the present embodiment, the control unit 15 is further implemented to change a magnitude of the tension T1 to be applied to the medium 7 based on timing information 54 designating a timing of changing a magnitude of the tension T1.

When the tension bar 20 moves between the lower position PL and the upper position PT, the tension bar 20 does not always generate an abnormal noise in the entire range, but often generates an abnormal noise in a partial range between the lower position PL and the upper position PT. Specifically, in many cases, the tension bar 20 generates an abnormal noise at a position P1 within a certain range immediately before the tension bar 20 reaches the lower position PL after starting to move downward from the upper position PT, and at a position P2 within a certain range immediately after the tension bar 20 starts to move upward from the lower position PL. Therefore, the magnitude of the tension T1 may be changed at the positions P1 and P2 where the tension bar 20 generates the abnormal noise to prevent the generation of the abnormal noise.

In the present embodiment, the timing information 54 is position information of the moving tension bar 20. That is, the timing information 54 is implemented to use the position P1 and the position P2 within a movement range of the tension bar 20.

The control unit 15 is implemented to change the magnitude of the tension T1 to be applied to the medium 7 at a timing when the tension bar 20 is located at the position P1 and the position P2.

### Acquisition of Position Information

As illustrated in FIG. 2, in the present embodiment, the tension bar moving unit 21 includes the rotary unit 25 and a rotary encoder 55.

The rotary encoder 55 has a rotating disk 57 having a plurality of regular slits which are not illustrated. The rotary encoder 55 senses and counts the slits on the rotating disk 57 with an optical sensor made up of a set of a light emitting element and a light receiving element, which is not illustrated. The rotary encoder 55 can obtain an amount of rotation of the disk 57 from the number of the slits counted with the optical sensor.

In the present embodiment, since the disk 57 is fixed to the rotary shaft 26, the amount of rotation of the disk 57 is the amount of rotation of the rotary shaft 26. The tension bar 20 reciprocates between the lower position PL and the upper position PT as the arm part 27 swings due to the rotation of the rotary shaft 26. Therefore, based on a rotation direction and the amount of rotation of the disk 57, the position information indicating where the tension bar 20 moving up and down is located within the movement range can be acquired. That is, the rotary encoder 55 can identify whether the tension bar 20 is located at the position P1 and the position P2.

When the control unit 15 receives, via the rotary encoder 55, the timing information 54 indicating that the tension bar 20 is located at the position P1 or the position P2 where the abnormal noise is generated, the control unit 15 changes the magnitude of the tension T1 to be applied to the medium 7.

### Change of Magnitude of Tension

In the present embodiment, the change of the magnitude of the tension T1 is implemented to operate the tension bar moving unit 21 of the tension applying unit 19 to change the magnitude of the tension T1 from a magnitude T₁₁ before a change to T₁₂ smaller than T₁₁.

That is, when the tension bar 20 starts moving at the position P1 toward the lower position PL, the magnitude of the tension T1 is changed from T₁₁ to T₁₂ by applying a torque in an opposite direction from the movement direction to the tension bar 20 via the rotary unit 25 of the tension bar moving unit 21. It is confirmed in advance that the magnitude T₁₂ of the tension T1 is changed from T₁₁ to prevent an abnormal noise from occurring. Further, when the tension bar 20 reaches the lower position PL, the downward movement stops.

When the tension bar 20 moves upward at the position P2 from the lower position PL toward the upper position PT, the tension T1 is maintained at T₁₂. When the tension bar 20 moves upward and passes the range of the position P2, the magnitude of the tension T1 is set to T₁₃. Here, T₁₃ is smaller than T₁₁. When the tension bar 20 moves upward at the position P2, the tension T1 can also be set to a designated value between T₁₂ and T₁₃.

When the tension bar 20 starts moving at the position P1 toward the lower position PL, the torque in the opposite direction may be applied to the extent that the movement of the tension bar 20 stops via the rotary unit 25.

That is, in the extra length part 30, the magnitude of the tension T1 may be changed from T₁₁ to a magnitude smaller than T₁₂ so that the medium 7 fed from the feeding unit 2 is slightly loosened. In this case, the torque in the opposite direction is then released to eliminate the slack. It is desirable to set the magnitude of the tension T1 to T₁₂ in a state in which the slack is eliminated.

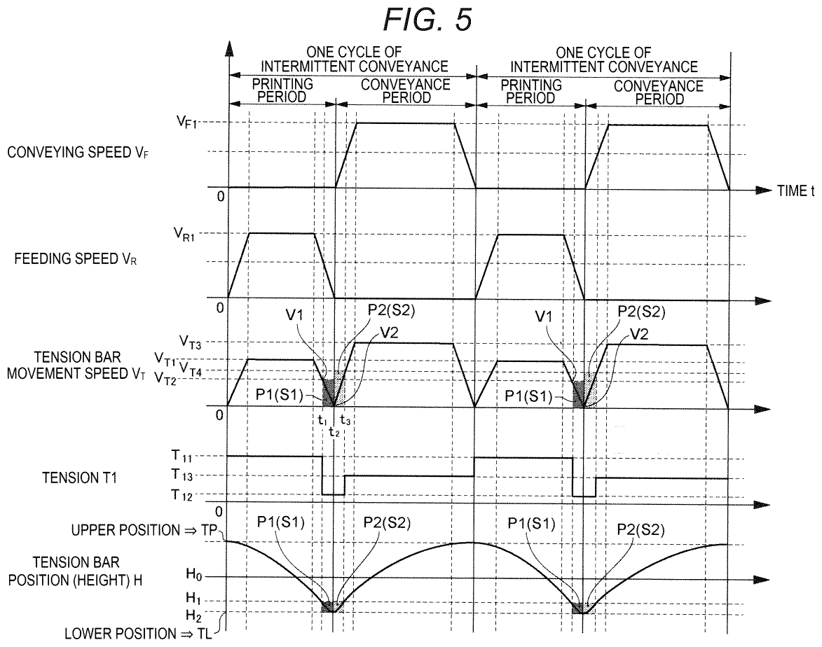

FIG. 5 is a time chart illustrating a relationship between the above-described operation states of the feeding unit 2, the conveying unit 3, and the tension bar moving unit 21 by the control unit 15 and changes of a position H of the tension bar 20 in a height direction and the tension T1.

FIG. 5 illustrates a change in a conveying speed V_{F} of the medium 7 by the conveying unit 3, a change in a feeding speed V_{R} of the medium 7 by the feeding unit 2, a change in a movement speed V_{T} of the tension bar 20, a change in the magnitude of the tension T1, and a change in the height position H in the movement range between the lower position PL and the upper position PT of the tension bar 20 with a horizontal axis as time t. Similar changes are repeated for each cycle of the intermittent conveyance of the conveying unit 3.

As illustrated in FIG. 5, the tension T1 is changed from T₁₁ before the change to T 12 when the position H of the tension bar 20 is at P1 and P2. Accordingly, generation of an abnormal noise is prevented.

### Description of Functions of Embodiment 1

Next, functions of Embodiment 1 will be described with reference to FIGS. 3 and 5.

In synchronization with the intermittent conveyance by the conveying unit 3, the tension bar 20 repeats the up and down movement in the movement range between the upper position PT and the lower position PL. When the tension bar 20 moves downward and passes through the position P1, the timing information 54 indicating that the tension bar 20 passes through the position P1 is transmitted to the control unit 15. When the tension bar 20 starts to move upward and passes through the position P2, the timing information 54 indicating that the tension bar 20 passes through the position P2 is transmitted to the control unit 15. That is, the control unit receives the timing information 54 indicating a timing to vibrate the tension bar 20.

Upon receiving the timing information 54, the control unit 15 changes the magnitude of the tension T1 from T₁₁ to T₁₂.

### Description of Effects of Embodiment 1

(1) When the medium 7 is conveyed in a state in which the tension bar 20 is in contact with the conveyed medium 7 to apply the tension T1, an abnormal noise may be generated from a part where the tension bar 20 and the medium 7 slide against each other.

In the present embodiment, the conveyance device includes the tension bar 20 that is disposed to be movable between the feeding unit 2 and the conveying unit 3 in the conveying path 18 along which the medium 7 is conveyed, and presses the medium 7 to apply the tension T1 thereto, and the tension bar moving unit 21 that moves the tension bar 20. Further, the conveyance device includes the control unit 15 that controls each of operations performed by the feeding unit 2, the conveying unit 3, and the tension bar moving unit 21. Further, the control unit 15 is implemented to change the magnitude of the tension T1 based on the timing information 54 designating a timing of changing a magnitude of the tension T1.

Accordingly, since the magnitude of the tension T1 applied to the medium 7 of the tension bar 20 that slides on the medium 7 changes, it is possible to deviate from the sliding state in which an abnormal noise is generated, and thus it is possible to prevent the generation of the abnormal noise.

Since the magnitude of the tension T1 is changed based on the timing information 54, the magnitude of the tension T1 can be changed at a timing of a state in which the abnormal noise is generated, that is, at an appropriate timing, and the generation of the abnormal noise can be prevented.
(2) In the present embodiment, the timing information 54 is information on the positions P1 and P2 in a movement direction of the moving tension bar 20. Accordingly, it is possible to change the magnitude of the tension T1 at an appropriate timing based on the information on the positions P1 and P2 of the tension bar 20, thereby preventing the generation of the abnormal noise.
(3) In the present embodiment, since the information on the positions P1 and P2 of the tension bar 20 is acquired via the rotary encoder 55, the information on the positions P1 and P2 can be acquired with a simple structure.

### Embodiment 2

Subsequently, the conveyance device 52 according to Embodiment 2 is described with reference to FIGS. 3 to 5. The same parts as in Embodiment 1 are denoted by the same reference numerals and signs, and the description of the configurations of the parts and effects corresponding to the configurations is omitted.

The tension bar 20 has an acceleration area, a constant speed area, and a deceleration area as a speed when moving between the lower position PL and the upper position PT. Specifically, when the tension bar 20 starts to move downward from the upper position PT, the tension bar 20 moves through an acceleration area where the speed gradually increases, a constant speed area where the speed is constant, and a deceleration area where the speed gradually decreases. The same applies to when the tension bar 20 starts to move upward from the lower position PL.

As described above, the abnormal noise is generated at the position P1 when the tension bar 20 moves downward and the position P2 when the tension bar 20 moves upward. As will be described later, the discloser of the present application confirms that the tension bar 20 passes through the position P1 in a deceleration state and passes through the position P2 in an acceleration state. Therefore, a speed V1 when the tension bar 20 starts to pass through the position P1 in the deceleration state can be used as the timing information 54. Similarly, a speed V2 when the tension bar 20 starts to pass through the position P2 in the acceleration state can be used as the timing information 54.

That is, in the present embodiment, the timing information 54 is the speed V1 and the speed V2, which are the speed information of the moving tension bar 20.

### Acquisition of Speed Information

The rotary encoder 55 can obtain a rotation speed of the disk 57 from the number of slits per unit time counted by the optical sensor. The rotation speed of the disk 57 has a certain relation with the movement speed of the tension bar 20.

In the present embodiment, since the disk 57 is fixed to the rotary shaft 26, the rotation speed of the disk 57 is the rotation speed of the rotary shaft 26. The tension bar 20 reciprocates between the lower position PL and the upper position PT as the arm part 27 swings due to the rotation of the rotary shaft 26. Therefore, based on the rotation direction and the rotation speed of the disk 57, the speed information of the tension bar 20 moving up and down can be acquired. That is, the rotary encoder 55 can identify whether the tension bar 20 is at the speed V1 and the speed V2.

When the control unit 15 receives the timing information 54 indicating the speed V1 and the speed V2 at which the tension bar 20 generates the abnormal noise via the rotary encoder 55, the control unit 15 changes the magnitude of the tension T1 applied to the medium 7.

As illustrated in the time chart of FIG. 5, when a movement speed V_{T} of the tension bar 20 moves downward in the deceleration area and reaches the speed V1, the magnitude of the tension T1 is changed from T₁₁ to T₁₂.

In addition, in the acceleration area in which the tension bar 20 starts to move upward from the lower position PL toward the upper position PT, the magnitude of the tension T1 when the movement speed V_{T} becomes the speed V2 is T₁₂. Specifically, in a state in which the tension bar 20 is positioned at the lower position PL, the magnitude of the tension T1 is T₁₂, and the tension bar 20 starts to move from the lower position PL toward the upper position PT in a state in which the magnitude T₁₂ is maintained.

Further, when the movement speed V_{T} of the tension bar 20 reaches a speed V_{T4} at a timing after the position P2, the magnitude of the tension T1 is set to T₁₃. Subsequently, when one cycle of the intermittent conveyance of the conveying unit 3 ends, that is, when the conveying unit 3 stops and the movement speed V_{T} of the tension bar 20 becomes zero, the magnitude of the tension T1 is changed from T₁₃ to T₁₁.

During a printing period when the conveying unit 3 is stopped, the movement speed V_{T} of the tension bar 20 is set to move from an origin position where the speed is zero through an acceleration area, and then enter a constant speed area when it reaches a speed V_{T1}. At a preset timing before the end of the printing period, the area changes from the constant speed area to the deceleration area and returns to the origin position where the speed is zero. The timing is set to be the same as the timing at which the feeding speed of the feeding unit 2 changes from the constant speed area to the deceleration area.

In a conveyance period in which the conveying unit 3 is in a driving state, the movement speed V_{T} of the tension bar 20 is set to be in the constant speed area when the speed becomes a speed V_{T3} from the origin position where the speed is zero through the acceleration area. Here, the speed V_{T3} is set to be faster than the speed V_{T1}.

### Description of Effects of Embodiment 2

(1) In the present embodiment, the timing information 54 is the speed information V1 and V2 of the moving tension bar 20. Accordingly, the magnitude of the tension T1 applied to the medium 7 by the tension bar 20 can be changed at an appropriate timing by the speed information V1 and V2 of the tension bar 20.
(2) In the present embodiment, since the speed information V1 and V2 is acquired via the rotary encoder 55, the speed information V1 and V2 can be acquired with a simple structure.

### Embodiment 3

Next, the conveyance device 52 according to Embodiment 3 will be described with reference to FIGS. 3 and 5. The same parts as in Embodiment 1 or Embodiment 2 are denoted by the same reference numerals and signs, and the description of the configurations of the parts and effects corresponding to the configurations is omitted.

In the present embodiment, the control unit 15 is implemented to execute an operation of starting a downward movement of the tension bar 20 located at the upper position PT by the tension bar moving unit 21 after the conveying unit 3 stops, and moving the tension bar 20 located at the lower position PL upward by the tension bar moving unit 21 after the conveying unit 3 resumes the conveyance of the medium 7.

Therefore, by measuring a time T until the tension bar 20 reaches the position P1 after starting to move downward after the conveying unit 3 stops moving, whether the tension bar 20 is located at the position P1 and the position P2 can be identified without using the rotary encoder 55.

Further, in the present embodiment, the control unit 15 is implemented to change the magnitude of the tension T1 applied to the medium 7 in the following first predetermined time S1 and second predetermined time S2.
(1) The first predetermined time S1 is a predetermined time after the conveying unit 3 stops and immediately before the tension bar 20 reaches the lower position PL. The first predetermined time S1 is a length of time determined as the time when the tension bar 20 is located at the position P1, based on the measured time T.
(2) The second predetermined time S2 is a predetermined time after the conveying unit 3 resumes the conveyance of the medium 7 and immediately after the tension bar 20 starts to move upward from the lower position PL. The second predetermined time S2 is a length of time determined as the time when the tension bar 20 is located at the position P2, based on the measured time T.

That is, as illustrated in FIGS. 3 and 5, in the present embodiment, the timing information 54 is the first predetermined time S1 and the second predetermined time S2 corresponding to the positions P1 and P2.

### Description of Effects of Embodiment 3

(1) In the present embodiment, the timing information 54 includes (1) the first predetermined time S1 after the conveying unit 3 stops and immediately before the tension bar 20 reaches the lower position PL, and (2) the second predetermined time S2 after the conveying unit 3 resumes the conveyance of the medium 7 and immediately after the tension bar 20 starts to move upward from the lower position PL. Accordingly, the magnitude of the tension T1 applied to the medium 7 can be changed at an appropriate timing without using the rotary encoder 55.

### Other Embodiments

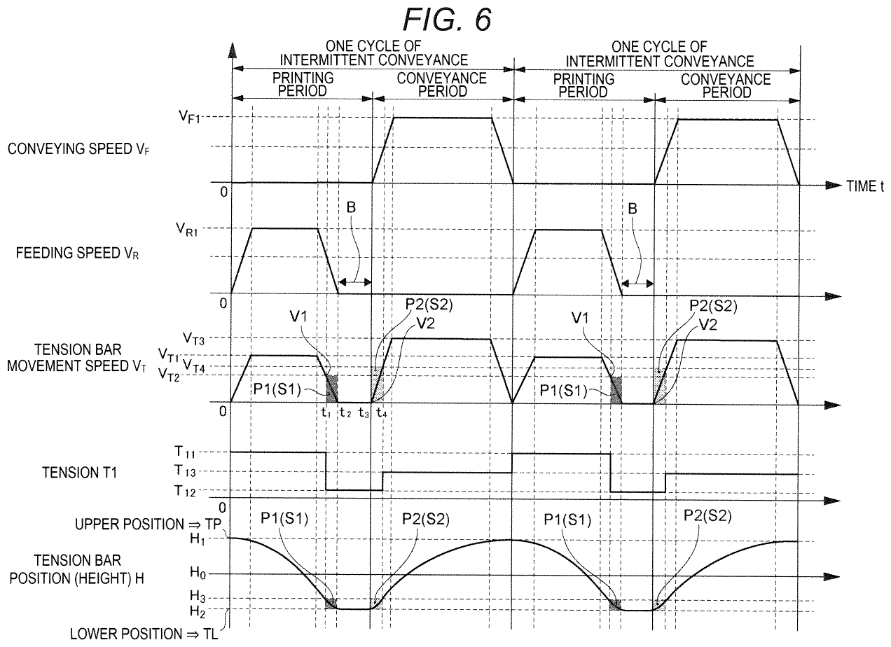

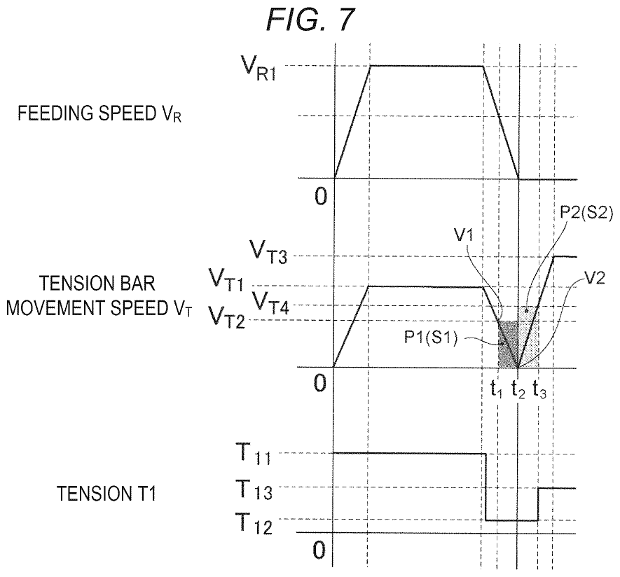

The conveyance device 52 and the recording device 1 according to the present disclosure basically have the configurations of the above-described embodiments, but as a matter of course, changes, omissions, and the like of some parts of the configurations can be made without departing from the scope of the present disclosure.
(1) In the above embodiment, as illustrated in the time chart of FIG. 5, the case in which the tension bar 20 is implemented to enter the acceleration area immediately after the speed reaches zero through the deceleration area is described. However, the present disclosure is not limited thereto, and may be implemented as illustrated in the time chart of FIG. 6. That is, when the speed of the tension bar 20 becomes zero through the deceleration area, the tension bar 20 may temporarily stop and then enter the acceleration area. In FIG. 6, reference sign B denotes a stop period.
(2) In the above embodiment, as illustrated in the time chart of FIG. 5, the tension T1 is changed from T₁₁ to T₁₂ when the tension bar 20 enters the position P1 or when the movement speed V_{T} becomes V1. Alternatively, as illustrated in FIG. 7, the tension T1 may be changed from T₁₁ to T₁₂ at a time point slightly before the tension bar 20 enters the position P1 or at a time point slightly before the movement speed V_{T} becomes V1.
(3) The magnitude of the tension T1 may be changed as follows.

By temporarily increasing a feeding amount of the medium 7 from the feeding unit 2 to loosen the medium 7 in the extra length part 30, the tension bar 20 and the medium 7 are temporarily brought into a non-contact state. Accordingly, the magnitude of the tension T1 changes. Thereafter, the feeding amount of the medium 7 from the feeding unit 2 is returned to the original state, and the tension bar 20 and the medium 7 are brought into contact with each other.
(4) The magnitude T₁₃ of the tension T1 may be the same as T₁₁. In this case, when the tension bar 20 starts to move at the position P1 toward the lower position PL, the magnitude of the tension T1 is changed from T₁₁ to T₁₂, when the tension bar 20 moves upward at the position P2 from the lower position PL toward the upper position PT, the tension T1 is maintained at T₁₂, and when the tension bar 20 moves upward and passes through the range of the position P2, the magnitude of the tension T1 is returned from T₁₂ to the magnitude before change T₁₁ again.
(5) In each of the above embodiments, the position information P1 and P2 or the speed information V1 and V2 as the timing information 54 is described as being acquired via the rotary encoder 55, and the present disclosure is not limited thereto. For example, the movement of the tension bar 20 may be acquired by calculation processing from a moving image captured by a camera. Alternatively, the position information P1 and P2 may be acquired via a position sensor such as a limit sensor.
(6) In each of the above embodiments, the conveyance device 52 is described as an element of the recording device 1, and the conveyance device 52 is not limited to an element of the recording device 1. For example, other devices such as a transfer device may include the moving tension bar 20.
(7) The tension bar 20 may be moved along a long guide groove, which is not illustrated. That is, the bar support shaft 24 of the tension bar 20 may be slidably engaged with the guide groove to guide the movement of the tension bar 20.
(8) The timing information 54 is preferably implemented such that the user can perform an adjustment to change the timing information 54 according to the state in which an abnormal noise is actually generated.

What is claimed is:

1. A conveyance device comprising:
a feeding unit configured to rotatably hold a roll body around which a medium is wound and to feed the medium from the roll body;
a conveying unit configured to intermittently convey the medium fed from the roll body in a conveying direction;
a tension bar configured to press the medium to apply a tension, the tension bar being movably disposed between the feeding unit and the conveying unit in a conveying path along which the medium is conveyed;
a tension bar moving unit configured to move the tension bar; and
a control unit configured to control each of operations performed by the feeding unit, the conveying unit, and the tension bar moving unit, wherein
the control unit changes a magnitude of the tension based on timing information designating a timing at which a magnitude of the tension is changed.

2. The conveyance device according to claim 1, wherein
the timing information is position information in a movement direction of the moving tension bar.

3. The conveyance device according to claim 2, wherein
the tension bar moving unit includes a rotary unit and a rotary encoder, and
the position information is acquired via the rotary encoder.

4. The conveyance device according to claim 1, wherein
the timing information is speed information of the moving tension bar.

5. The conveyance device according to claim 4, wherein
the tension bar moving unit includes a rotary unit and a rotary encoder, and
the speed information is acquired via the rotary encoder.

6. The conveyance device according to claim 1, wherein
the control unit is configured to execute an operation of starting a downward movement of the tension bar located at an upper position by the tension bar moving unit after the conveying unit stops, and moving the tension bar located at a lower position upward by the tension bar moving unit after the conveying unit resumes the conveyance of the medium, and
the timing information is (1) a first predetermined time after the conveying unit stops and immediately before the tension bar reaches the lower position, and (2) a second predetermined time after the conveying unit resumes the conveyance of the medium and immediately after the tension bar starts to move upward from the lower position.

7. A recording device comprising:
a recording unit configured to perform recording on a conveyed medium; and
a conveyance device located upstream of the recording unit in a conveying direction and configured to convey the medium toward the recording unit, wherein the conveyance device is the conveyance device according to claim 1.
